(19) United States
(12) Patent Application Publication
(10) Pub. No.: US 2002/0116101 A1
(43) Pub. Date: Aug. 22, 2002

(54) Torque control strategy for management of regenerative braking of a wheeled vehicle whose powertrain includes a rotary electric machine

(76) Inventors: Hitoshi Hashiba, Plymouth, MI (US); Masato Yoshino, Itami (JP); Dale Scott Crombez, Livonia, MI (US); Jack H. Xu, Ploching (DE); Kenneth James Farkas, Dearborn, MI (US); Kerry Eden Grand, Chesterfield, MI (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/133,945

(22) Filed: Apr. 25, 2002

Related U.S. Application Data
(63) Continuation of application No. 09/745,349, filed on Dec. 21, 2000, now abandoned.

(51) Int. Cl. G06F 17/00

(52) U.S. Cl. 701/22; 701/70; 701/84; 180/65.3

(57) ABSTRACT

A torque control strategy control for management of regenerative braking in a motor vehicle. A first processor (12) processes throttle request data (20) and torque modification data (40) from a second processor (14) to develop motor torque request data (28) for controlling rotary electric machine torque. The second processor processes brake request data (26), the throttle request data, and operating data from the at least one operating data source to develop friction brake torque data (30) for controlling friction brake torque applied to the vehicle and the torque modification data for the first processor. The two processors interact such that as long as the operating data from the at least one operating data source does not require that regenerative braking torque be limited, the torque modification data supplied to the first processor from the second processor equates to the brake torque request data, and the friction brake torque data does not cause the friction brakes to be applied, and when the operating data from the at least one operating data source calls for some limiting of the regenerative braking torque, the amount of limiting is subtracted from the torque modification data and the friction brake torque data equates to that amount of limiting for causing the friction brakes to be applied in that amount.

### BACKGROUND OF THE INVENTION

1. Field of the Invention

This invention relates generally to electric vehicles and partial electric vehicles. More specifically, it relates to a torque control strategy for management of regenerative braking in such vehicles.

2. Background Information

A wheeled automotive vehicle may comprise one or more electronic modules that control various aspects of powertrain operation. Certain vehicles have a powertrain that includes a rotary electric machine. A vehicle that comprises such as a machine as the sole prime mover is commonly referred to as an electric vehicle, and in such a vehicle, batteries or fuel cells are typical power supplies for the electric machine. Vehicles that include an electric machine in association with another prime mover, an internal combustion engine for example, are sometimes called partial electric vehicles or hybrid electric vehicles.

A powertrain control module (PCM) is a name that is sometimes given to an electronic module that processes certain data to control various aspects of powertrain operation. A rotary electric machine may be one device whose operation is under the control of a PCM. Sometimes the electric machine operates as a motor that makes a positive torque contribution to powertrain torque. At other times the electric machine operates as a generator that makes a negative torque contribution to powertrain torque. Positive torque contribution from the electric machine may appear as traction torque delivered through a drivetrain of the vehicle to at least some of the wheels to propel the vehicle. Negative torque contribution from the electric machine may be used to impose braking torque on the drivetrain to brake the vehicle. In a hybrid electric vehicle, positive and negative torque contributions from the electric machine may also be used to smooth torque fluctuations due to combustion events in an associated combustion engine.

When an electric machine imposes braking torque on the drivetrain to brake the vehicle, it is operating as an electric generator. Generated electricity may be used advantageously to regenerate an electric power supply such as a battery or fuel cell. Hence, such braking is commonly referred to as regenerative braking, or sometimes simply regen for short. A vehicle that possesses regenerative braking capability typically does not rely exclusively on such braking for the vehicle service brakes. While some energy recovery is made possible by regenerative braking, it is inappropriate at certain times to invoke regenerative braking. For example, the state of charge (SOC) of a battery, or battery bank, may be such that regenerative electric current from the electric machine should not be fed, either in whole or in part, to the battery or bank. In the absence of a suitable sink for such electric current, an alternate braking means is needed.

Hence, both full and partial electric vehicles employ some form of mechanical brakes, such as friction brakes at individual wheels. Mechanical friction brakes may be hydraulic-, pneumatic-, or electric-operated. It is known to use an electronic brake controller or brake control unit (BCU) to apply relative proportions of regenerative braking and friction braking when braking is called for.

### SUMMARY OF THE INVENTION

The present invention relates to a torque control strategy for management of regenerative braking that comprises novel inter-relationships between a PCM and a BCU. The inventive principles are believed to provide useful benefits including: an inherent ability to respond in suitable ways to various conditions that a vehicle may experience during operation, such as two-pedaling, rollback, different traction events, and gear selection reversals; more consistent brake and accelerator pedal responses and feels that contribute to improved vehicle driveablity; efficient energy recovery; and improved fault monitoring and management. The inter-relationships between the PCM and BCU provide torque control division, or apportionment, between the two that intentionally disallows the BCU from exercising direct control authority over drivetrain torque and the PCM from exercising direct control authority over brake torque. It is further contemplated that the inventive principles can provide certain mass-production manufacturing economies, while enabling each BCU/PCM system to be uniquely adapted to different electric or partial electric vehicles.

One general aspect of the invention relates a motor vehicle comprising road-engaging wheels, a powerplant comprising a rotary electric machine that is operatively coupled through a drivetrain to the road-engaging wheels and that is capable both of delivering traction torque to the wheels and of imposing regenerative braking torque on the wheels, and friction brakes for applying friction brake torque to the wheels. Throttle request data comes from a throttle request source, and brake request data, from a brake request source. At least one operating data source furnishes operating data that, at certain times, calls for limitation of regenerative braking torque.

A first electronic module comprises a processor for processing throttle request data from the throttle request source and torque modification data from a second electronic module to develop motor torque request data for controlling rotary electric machine torque. The second electronic module comprises a processor for processing brake request data from the brake request source, the throttle request data, and operating data from the at least one operating data source to develop friction brake torque data for controlling friction brake torque applied to the wheels and the torque modification data for the first electronic module.

The two modules have processing interaction such that as long as the operating data from the at least one operating data source does not require that regenerative braking torque be limited, the torque modification data supplied to the first electronic module from the second electronic module equates to the brake torque request data from the brake request source, and the friction brake torque data does not cause the friction brakes to be applied, and when the operating data from the at least one operating data source calls for some limiting of the regenerative braking torque, the amount of limiting is subtracted from the torque modification data and the friction brake torque data equates to that amount of limiting for causing the friction brakes to be applied in that amount.

Another general aspect of the invention relates to a control in which the torque management strategy just described is implemented.

Another general aspect of the invention relates to a method comprising the torque management strategy just described.

Further aspects will be seen in various features of a presently preferred embodiment of the invention that will be described in detail.

### BRIEF DESCRIPTION OF THE DRAWINGS

The drawings that will now be briefly described are incorporated herein to illustrate a preferred embodiment of the invention and a best mode presently contemplated for carrying out the invention.

FIG. 1 is a general schematic diagram of a representative torque controller for a vehicle powerplant, including a PCM and BCU, in accordance with principles of the present invention.

FIG. 2 is a flow diagram representing a strategy associated primarily with the PCM, but inter-related with the BCU, in accordance with principles of the present invention.

FIG. 3 is a flow diagram representing a strategy associated primarily with the BCU, but inter-related with the PCM, in accordance with principles of the present invention.

### DESCRIPTION OF THE PREFERRED EMBODIMENT(S)

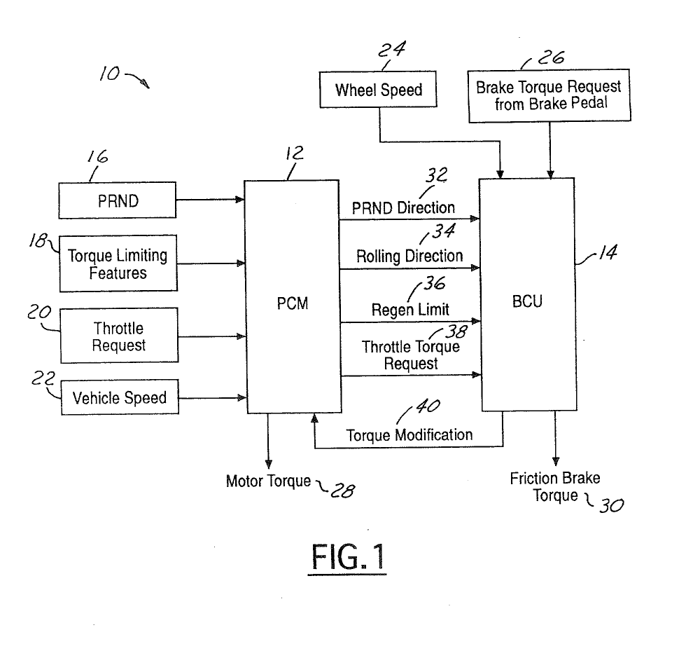

FIG. 1 shows a representative torque controller 10 for the powerplant of an electric automotive vehicle. It includes a powertrain control module (PCM) 12 and a brake control unit (BCU) 14. It should be appreciated that the descriptive term control module, or control unit, is used in a generic sense, and not in a limiting sense, to designate an electronic unit that comprises an assembly that comprises various electronic components, including a processor, for processing various data inputs and delivering various data outputs to perform selected functions in the manner herein described. The vehicle powerplant comprises a rotary electric machine that can operate either as an electric motor for propelling the vehicle or as an electric generator for braking the vehicle. The vehicle also includes a service brake system for braking the vehicle via the application of friction brakes. Application of the friction brakes may be accomplished in any suitable way, such as by a driver of the vehicle depressing a brake pedal to actuate the brakes via electric-, hydraulic-, or pneumatic-actuation. A drivetrain from the electric motor to driven wheels includes a multi-gear transmission that is selectively operable by the driver to different gears. In the vehicle described here, those gears are Park (P), Reverse (R), Neutral (N), and Drive (D). When placed in Drive, the transmission enables the electric machine, operating as a motor, to propel the vehicle in a forward direction. When placed in Reverse, the transmission enables the electric machine, operating as a motor, to propel the vehicle in a rearward direction. When placed in Park or Neutral, rotary motion cannot be transmitted from the electric machine to the wheels, however it may be decided to allow rotary motion to be transmitted from the wheels to the electric machine while in Park or Neutral. The difference between Park and Neutral is that in the former gear, a means for locking the drivetrain at near zero vehicle speeds (typically with the use of a parking pawl) is applied, while in the latter gear the locking means is not applied. For propelling the vehicle in either forward or reverse, there is an accelerator, or throttle, that is operated by the driver, typically by an accelerator pedal.

Data inputs that are utilized by PCM 12 pursuant to principles of the invention include: selected transmission gear data 16, typically obtained from the transmission and/or its shift mechanism; certain torque limiting factors 18, such as any factor that may inhibit the energy storage device (battery) from receiving or delivering electric current (i.e. high state of charge), or any factor that may inhibit any part of the drivetrain from producing regenerative torque (i.e. drivetrain temperatures, battery temperatures, high voltage limits, etc.); throttle request data 20, typically obtained from a sensor, such as a throttle position sensor, associated with the accelerator pedal; and vehicle speed data 22. Communication of electronic data between various devices in the vehicle occurs via a communication, or data, bus, on which data is broadcast at suitable update rates.

Data inputs that are utilized by BCU 14 pursuant to principles of the invention include: wheel speed data 24, typically obtained from wheel speed sensors; and brake torque request data 26, obtained from any suitable sensor for sensing the extent to which the driver is depressing a brake pedal, i.e. a stroke sensor or a pressure sensor for example. One data output of PCM 12 is motor torque 28 for operating the rotary electric machine as a motor, and one data output of BCU 14 is friction brake torque 30 for operating the friction brakes.

Other data outputs of PCM 12 provide data inputs to BCU 14, and they include: data 32 for distinguishing the placement of the transmission in Drive gear from placement in Reverse gear (Park and Neutral gears may be considered to be Drive gears); data 34 for identifying the actual direction, either forward or reverse, in which the vehicle is moving; data 36 defining a regeneration limit; and data 38 corresponding to the throttle torque request, as modified by certain torque limiting factors, under certain conditions. Another data output of BCU 14 that forms an input to PCM 12 is data 40 that defines a calculated torque modification.

Braking of the vehicle may be accomplished either by the application of the friction brakes at the individual road-engaging wheels, or by regenerative braking that uses kinetic energy of the moving vehicle to operate the electric machine of the powerplant as an electric generator.

Acceleration of the vehicle is requested by depressing the accelerator pedal of the vehicle. The throttle position sensor monitors the extent to which the accelerator pedal is being depressed and in turn generates throttle request data 20. This request may be either torque that would accelerate the vehicle or torque that would decelerate the vehicle. A throttle request and an accelerator request are understood here to be synonymous.

A throttle request that decelerates a vehicle may be generated at certain speeds and at throttle positions at or near lift throttle and simulate the lift throttle deceleration torque that is produced in a vehicle equipped with a conventional internal combustion (IC) engine and transmission. This lift throttle deceleration torque is sometimes referred to as compression braking torque. In the case of a vehicle equipped with a rotary electric machine, the compression braking becomes regenerative compression braking.

PCM 12 controls powertrain torque developed by the vehicle powerplant, in this instance motor torque developed by the rotary electric machine operating as an electric motor. The vehicle powertrain comprises a drivetrain through which torque, as determined by the PCM's control of the powerplant, is applied to road-engaging wheels of the vehicle. The applied torque is the algebraic summation of drive torque (a positive torque), regenerative braking torque (a negative torque), and compression braking torque (a negative torque). Regenerative braking is any form of braking imposed on the powertrain which recovers kinetic energy from the powertrain for immediate use elsewhere or for later use in any of various ways by temporary storage of recovered energy in a suitable on-board storage medium.

It is PCM 12 that maintains control over powertrain torque, and although BCU 14 may request a modification of that torque by torque modification data 40 which it supplies to PCM 12, any requested torque modification data 40 is subject to values of the data which PCM 12 itself furnishes to BCU 14, namely regeneration limit data 36 and throttle torque request data 38, and in any event, PCM 12 will not process requested torque modification data 40 in any situation where it determines that processing of such torque modification request data would be inappropriate for presently prevailing values of all data that PCM 12 utilizes in controlling the powertrain.

Likewise it is BCU 14 that maintains control over friction brake torque, and although PCM 12 may in effect, for various combinations of values of regeneration limit data 36 and throttle torque request data 38 which it calculates, request BCU 14 to request friction brake torque, BCU 14 will not process friction brake torque request data in any situation where it determines that processing of such brake torque request data would be inappropriate for presently prevailing values of all data that BCU 14 utilizes in controlling the friction brakes.

Transfer of data between PCM 12 and BCU 14 may be accomplished by any suitable medium, such as the communication bus, and it is understood that data from all relevant sources is also made available to PCM 12 and BCU 14 on such a data link, even if not expressly shown in the drawings.

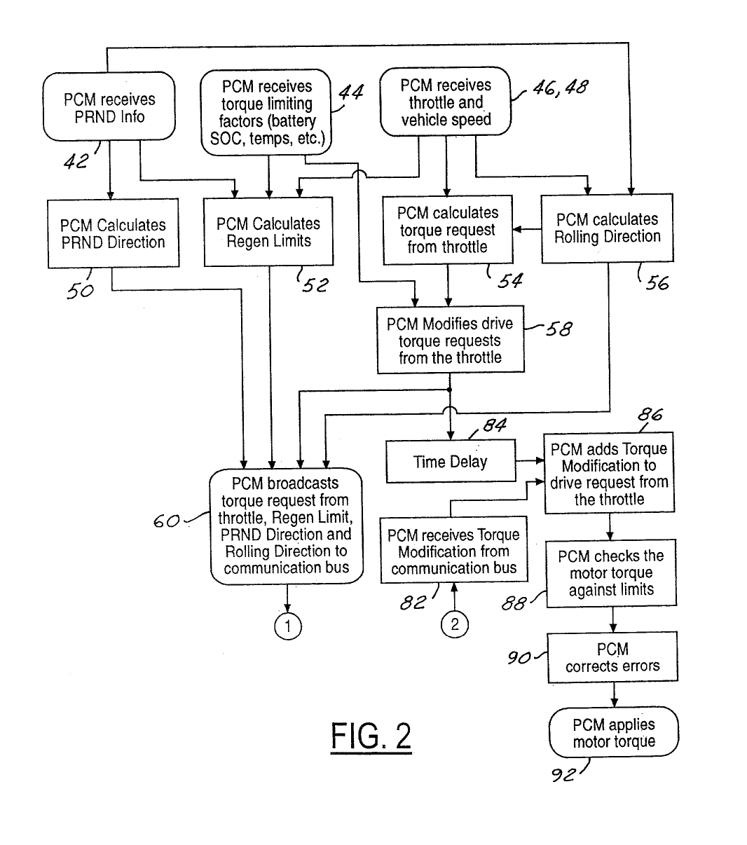

FIG. 2 shows various processing data steps performed by PCM 12. They include: a step 42 of receiving selected transmission gear 16; a step 44 of receiving torque limiting factors 18; a step 46 of receiving throttle request 20; and a step 48 of receiving vehicle speed 22.

PCM 12 performs various calculational steps using that received data, as shown. A step 50 calculates the direction, either forward (D,P,R) or non-forward (N), in which the vehicle will be propelled by the powerplant for the particular selected transmission gear. The result of the calculation is the data signal 32. A step 52 calculates the regeneration limits data, and the result of that calculation is the data signal 36. A step 54 calculates torque request data corresponding to accelerator pedal position, and the result is used in further processing within PCM 12. A step 56 calculates data 34 identifying the actual direction of vehicle motion (either reverse or non-reverse), and that data is both broadcast on the vehicle communication bus and used in further processing by PCM 12.

A step 58 processes the torque request data resulting from step 54 and the torque limiting factor data from step 44 so as to modify the torque request from the accelerator pedal in those circumstances where it is deemed appropriate for torque limiting factors to impose a limitation on such torque request. Hence, step 58 can cause an attenuation in the actual motor drive torque from that requested by the accelerator pedal in situations when factors such as source current limits (for example, battery SOC), temperature, vehicle speed, etc., indicate that the powerplant should not be developing motor torque greater than some limit. The result of step 58 is the throttle torque request data 38. It may be noted that the throttle torque request data 38 may exceed the regen limit data 36 as additional processing of throttle torque request data 38 will be performed. Step 60 shows that the results of calculational steps 50, 52, 56, and 58 are broadcast on the communication bus, or data link, where they are made available to BCU 14.

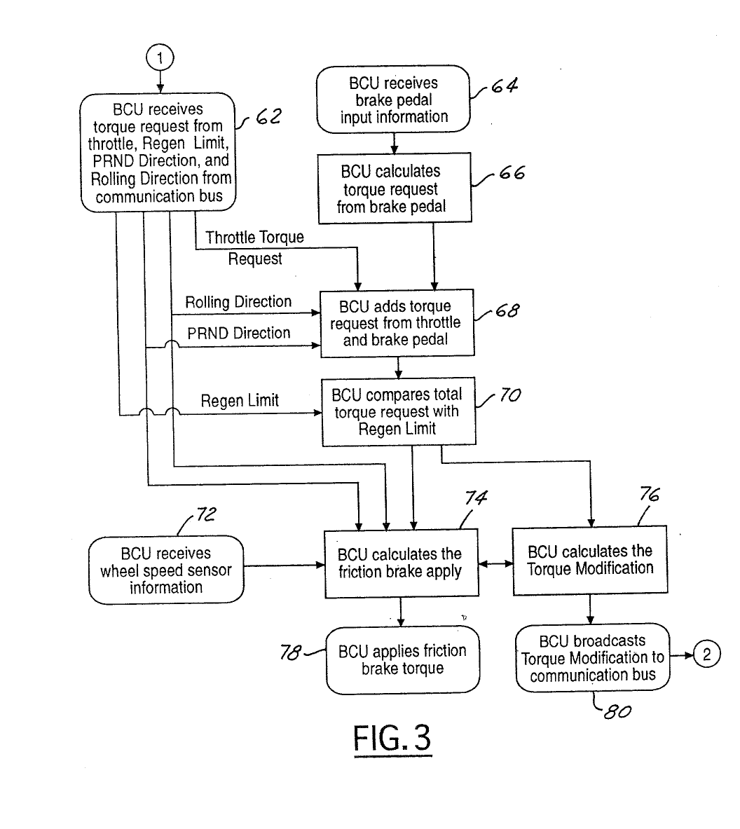

PCM 12 performs additional processing of the data from step 58 before motor torque data 28 is calculated and broadcast to an electric control circuit associated with the rotary electric machine. That processing provides for the torque modification data 40 from BCU 14 to be taken into account before motor torque data 28 is allowed to be effective on the powerplant. This additional processing will be described later after the ensuing description of FIG. 3 disclosing processing performed by BCU 14.

In the last Figure a step 62 shows receipt by BCU 14 of the data broadcast by PCM 12 at step 60. A step 64 shows receipt by BCU 14 of brake pedal application data. At step 66, BCU 14 processes the latter data to calculate a corresponding brake torque request. At step 68, the brake torque request data from step 66 is algebraically summed with the throttle torque request data 38 received from PCM 12. Rolling direction and PRND direction may be used in this step 68 to ensure that the torque signs of the throttle torque request and brake torque request are properly accounted for in the calculation. A step 70 compares the total against the regeneration limit data 36 received from PCM 12, and acts to limit the total should the latter exceed the regeneration limit.

Step 72 shows that wheel speed sensor data is also an input to BCU 14. BCU 14 processes that data, the vehicle directional data, and the brake torque request data, as possibly limited by the regeneration limit data, to calculate desired friction brake torque data (step 74) and torque modification data (step 76). The desired friction brake torque calculation of step 74 is used to apply that torque to the friction brakes (step 78). This friction brake torque data 30 represents the braking torque that is beyond the regen limit data 36 and cannot be produced by the powertrain. The torque modification data 40 from step 76 represents the change or modification to the throttle torque request data 38 that is required to ultimately apply appropriate motor torque data 28 and is broadcast on the communication bus (step 80).

PCM 12 receives that broadcast data, as shown by step 82 in FIG. 2. PCM 12 processes the data from step 58, after a time delay (step 84) that takes into account processing time for BCU 14 to process data received from PCM 12 develop and broadcast torque modification data 40, and torque modification data 40 (step 86). The data calculation resulting from step 86 is compared against motor torque limit data (step 88), corrected as appropriate in view of those limits (step 90), and then applied to the rotary electric machine of the powerplant (step 92).

From the foregoing description, it can be understood that PCM 12 processes input data comprising the four data inputs 16, 18, 20, and 22 in FIG. 1 to create output data comprising the four data outputs 32, 34, 36, and 38. That data output is then processed by BCU 14 in conjunction with brake torque request data 26. BCU 14 calculates the total torque demand at the wheels by algebraically summing brake torque request data 26 and throttle torque request data 38. The next task for BCU 14 is to develop torque modification data 40 for use by PCM 12 and friction brake torque data 30 for operating the friction brakes, while assuring that such data is appropriate to relevant torque limiting factors that may call for limiting the extent to which regenerative braking should be invoked.

As long as the torque limiting factors do not require that the regenerative braking torque be limited, the torque modification request data 40 that is supplied to PCM 12 by BCU 14 equates to the brake torque request data 26 from the brake pedal sensor, and the friction brakes are not applied. To the extent that the torque limiting factors call for some limiting of the regenerative braking torque, the amount of limiting is in effect subtracted from what would otherwise be the value of the torque modification data 40, and that amount of limiting is reflected in the friction brake torque data 30 to cause the friction brakes to be applied in that amount. Hence, at any given time, the total torque being produced by the rotary electric machine and the friction brakes is always equal to the total torque being requested by the driver through the brake and accelerator pedal while at the same time, maintaining regenerative braking torque to the regenerative braking limits.

It is believed that the disclosed strategy represents an efficient and effective way for enhancing various aspects of the operation of electric and hybrid electric vehicles.

What is claimed is:

1. A motor vehicle comprising:
road-engaging wheels;
a powerplant comprising a rotary electric machine that is operatively coupled through a drivetrain to the road-engaging wheels and that is capable both of delivering traction torque to the wheels and of imposing regenerative braking torque on the wheels;
friction brakes for applying friction brake torque to the wheels;
a throttle request source;
a brake request source;
at least one operating data source furnishing operating data that, at certain times, calls for limitation of regenerative braking torque;
a first electronic module comprising a processor for processing vehicle speed data, throttle request data from the throttle request source, and torque modification data from a second electronic module to develop motor torque request data for controlling rotary electric machine torque;
the second electronic module comprising a processor for processing wheel speed data, brake request data from the brake request source, the throttle request data, and operating data from the at least one operating data source to develop friction brake torque data for controlling friction brake torque applied to the wheels and the torque modification data for the first electronic module;
the two modules having processing interaction such that as long as the operating data from the at least one operating data source does not require that regenerative braking torque be limited, the torque modification data supplied to the first electronic module from the second electronic module equates to the brake torque request data from the brake request source, and the friction brake torque data does not cause the friction brakes to be applied, and when the operating data from the at least one operating data source calls for some limiting of the regenerative braking torque, the amount of limiting is subtracted from the torque modification data and the friction brake torque data equates to that amount of limiting for causing the friction brakes to be applied in that amount.

2. A motor vehicle as set forth in claim 1 in which the at least one operating data source furnishing operating data that, at certain times, calls for limitation of regenerative braking torque comprises a data source furnishing limitations on an on-board current source and sink for the rotary electric machine.

3. A motor vehicle as set forth in claim 2 in which the on-board current source and sink comprises a battery.

4. A motor vehicle as set forth in claim 1 in which each module also processes vehicle rolling direction data defining rolling direction of the vehicle and drive gear selection data distinguishing forward from non-forward drive gear selection in the respective development of the motor torque request data and the torque modification data.

5. A control for a motor vehicle that has road-engaging wheels, a powerplant that includes a rotary electric machine that is operatively coupled through a drivetrain to the road-engaging wheels and that is capable both of delivering traction torque to the wheels and of imposing regenerative braking torque on the wheels, and friction brakes for applying friction brake torque to the wheels, the control comprising:
a throttle request source;
a brake request source;
at least one operating data source furnishing operating data that, at certain times, calls for limitation of regenerative braking torque;
a first processor for processing vehicle speed data, throttle request data from the throttle request source, and torque modification data from a second processor to develop motor torque request data for controlling rotary electric machine torque;
the second electronic processor processing wheel speed data, brake request data from the brake request source, the throttle request data, and operating data from the at least one operating data source to develop friction brake torque data for controlling friction brake torque applied to the wheels and the torque modification data for the first electronic module;
the two processors having processing interaction such that as long as the operating data from the at least one operating data source does not require that regenerative braking torque be limited, the torque modification data supplied to the first electronic module from the second electronic module equates to the brake torque request data from the brake request source, and the friction brake torque data does not cause the friction brakes to be applied, and when the operating data from the at least one operating data source calls for some limiting of the regenerative braking torque, the amount of limiting is subtracted from the torque modification data and the friction brake torque data equates to that amount of limiting for causing the friction brakes to be applied in that amount.

6. A control as set forth in claim 5 in which the at least one operating data source furnishing operating data that, at certain times, calls for limitation of regenerative braking torque comprises a data source furnishing limitations on an on-board current source and sink for the rotary electric machine.

7. A control as set forth in claim 5 in which each processor also processes vehicle rolling direction data defining rolling direction of the vehicle and drive gear selection data distinguishing forward from non-forward drive gear selection in the respective development of the motor torque request data and the torque modification data.

8. A control as set forth in claim 5 in which each processor is contained in a respective module and the modules are in communication via a data bus.

9. A method of operating a motor vehicle that has road-engaging wheels, a powerplant comprising a rotary electric machine that is operatively coupled through a drivetrain to the road-engaging wheels and that is capable both of delivering traction torque to the wheels and of imposing regenerative braking torque on the wheels, and friction brakes for applying friction brake torque to the wheels, a throttle request source, a brake request source, and at least one operating data source furnishing operating data that, at certain times, calls for limitation of regenerative braking torque, the method comprising:
processing, in a first processor, vehicle speed data, throttle request data from the throttle request source, and torque modification data from a second processor, to develop motor torque request data for controlling rotary electric machine torque;
processing, in the second processor, wheel speed data, brake request data from the brake request source, the throttle request data, and operating data from the at least one operating data source to develop friction brake torque data for controlling friction brake torque applied to the wheels and the torque modification data for the first electronic module; wherein
the processing by the respective processors has interaction such that as long as the operating data from the at least one operating data source does not require that regenerative braking torque be limited, the torque modification data supplied to the first processor from the second electronic module equates to the brake torque request data from the brake request source, and the friction brake torque data does not cause the friction brakes to be applied, and when the operating data from the at least one operating data source calls for some limiting of the regenerative braking torque, the amount of limiting is subtracted from the torque modification data and the friction brake torque data equates to that amount of limiting for causing the friction brakes to be applied in that amount.

10. A method as set forth in claim 9 in which each processor also processes vehicle rolling direction data defining rolling direction of the vehicle and drive gear selection data distinguishing forward from non-forward drive gear selection in the respective development of the motor torque request data and the torque modification data.
